(19) United States
(12) Patent Application Publication
(10) Pub. No.: US 2022/0027831 A1
(43) Pub. Date: Jan. 27, 2022

(54) SYSTEM AND METHOD FOR SECURITY ANALYST MODELING AND MANAGEMENT

(71) Applicant: Penfield.AI Inc., Toronto (CA)

(72) Inventors: Hassan KHAN, Waterloo (CA); Tahseen SHABAB, Toronto (CA)

(21) Appl. No.: 17/443,688

(22) Filed: Jul. 27, 2021

Related U.S. Application Data
(60) Provisional application No. 63/056,967, filed on Jul. 27, 2020.

(51) Int. Cl. G06Q 10/06; G06Q 10/10; G06Q 30/00; G06F 16/906; G06N 20/00; G09B 19/00

(52) U.S. Cl. CPC G06Q 10/06398; G06Q 10/105; G06Q 10/063112; G06Q 10/06395; G09B 19/0053; G06Q 10/063118; G06F 16/906; G06N 20/00; G06Q 30/018

(57) ABSTRACT

Systems and methods for managing incoming cybersecurity events. Incoming security events are first classified based on stored event profiles from previous events. Multiple analysts with relevant experience and background are determined based on the analysts' stored profiles. The incoming event is assigned and dispatched as necessary to one of these analysts. Analyst stress levels and mood is assessed, and the assessments are stored in the analyst profiles. Analyst resolution steps and performance against those steps in resolving the events are also stored in the relevant analyst profiles and in an event record database. QA reviews of resolved events are conducted when norm deviant circumstances arise. AI and process mining techniques are used in classifying the incoming events, assigning the incoming events to the relevant analyst, and determining lessons to be learned from previous events. The analyst profiles models specific analyst behaviour and are used for assigning incoming events.

### RELATED APPLICATIONS

This application claims the benefit of U.S. Provisional Application No. 63/056,967 filed on Jul. 27, 2020.

### TECHNICAL FIELD

The present invention relates to analysis and interaction software. More specifically, the present invention relates to systems and methods relating to the analysis of incoming events, the analysis of professionals who are to deal with these incoming events, and the analysis of the actions of the professionals when dealing with incoming events.

### BACKGROUND

The widespread use of AI and AI enabled systems for everything from agriculture to legal services has enabled the automation of various tasks which are static in nature. However, even with such widespread use of automation and AI, one can see an increased need for human workers to work in tandem with intelligent systems in dynamic environments where tasks are adaptive in nature and human skill sets change over time. Such dynamic systems are prominent in fields such as cybersecurity, where attack landscapes continuously change (e.g., hackers always changing their maneuvers), network usage likewise continues to change, and new vulnerabilities/behaviours are introduced with the adoption of new technology. These dynamic systems not only generate vast amounts of data, to address the tasks needed by these systems, human workers need to ingest and digest greater and greater amounts of data. This rise in the amount of data that workers need to process requires that such workers need to be more efficient in not only addressing such tasks but also in keeping up with the latest variants of tasks.

Current systems that deal with professionals that analyze data or provide professional services (e.g., data analysts, cybersecurity analysts, etc.) are inadequate when it comes to addressing the issues that arise due to the very fast pace of technology. These systems do not to model the skill sets of analysts in real time, are inefficient when it assigns tasks to analysts, and do not provide suitable quality assurance tests for the work product of the analysts. In addition, these systems are unable to monitor the skill sets of the analysts nor are they able to provide/facilitate suitable training for analysts with lacking skill sets.

In a cybersecurity context, current systems randomly assign tasks to random analysts, usually without any consideration for an analyst's skill set or experience. Sometimes, current systems assign tasks on an ad hoc basis and, unfortunately, this leads to inefficiencies. A heuristics-based approach has also been used in assigning tasks. However, this approach also has issues as a heuristics-based approach does not take into account the efficacy of analysts, the speed of resolution of tasks nor does it take into account the accuracy of the analysts' solutions. From the above, there is, therefore, a need for systems and methods that mitigate if not overcome the shortcoming of currently used systems. Preferably, such systems should address differing analyst skill sets, differing requirements for different tasks, and the need for continuous training for such analysts.

### SUMMARY

The present invention provides systems and methods for managing incoming cybersecurity events. Incoming security events are first classified or categorized based on stored event profiles from previous events. Multiple analysts with the experience and background to address the incoming event are then determined based on the analysts' stored profiles. The incoming event is then assigned and dispatched as necessary to one of these analysts. Analyst stress levels and mood are assessed and the assessments are stored in the analyst profiles. Analyst performance in resolving the events is also stored in the relevant analyst profiles. All of the analyst interactions while dealing with each incoming event is stored on an event record database and these event records are used to assess analyst performance and to assess potential efficiencies that can be implemented. Quality assurance reviews of resolved events are also conducted in conjunction with the application of process mining techniques on the event records. AI techniques may be used in classifying the incoming events, in assigning the incoming events to the relevant analyst, and in the process mining techniques. The analyst profiles operate as a model of analyst behaviour and are used as one basis for the assigning of incoming events.

In a first aspect, the present document describes a system for managing incoming events and analysts, the system comprising:
an event classifier module for classifying an incoming event;
an analyst database storing analyst profiles of said analysts;
a processing module for determining which analyst is to be assigned to address said incoming event based on an analyst profile in said analyst database;
a routing engine for routing data related to said incoming event to an analyst based on a determination by said processing module as to which analyst is to be assigned to address said incoming event; wherein
said processing module receives data regarding said incoming event from said event classifier module and receives analyst profiles from said analyst database;
said processing module determines which analyst is to be assigned to said incoming event based on said analyst profiles and on a classification of said incoming event.

In a second aspect, the present document describes a method for addressing an incoming event, the method comprising:

a) receiving said incoming event;

b) classifying said incoming event based on stored event profiles;

c) determining at least one analyst suitable to address said incoming event, said at least one analyst being determined to be suitable based on a plurality of stored analyst profiles;

d) assigning said incoming event to one of said at least one analyst determined in step c);

e) dispatching data relating to said incoming event to said analyst assigned in step d).

In another aspect, the present document describes a system for extracting useful information from interactions by analysts while addressing incoming cybersecurity events, the system comprising:
an event record database, said event record database containing records of interactions by analysts for every event said analysts encounter as said analysts resolve each event;
a process mining module for determining patterns in said interactions used while said analysts are addressing incoming events;
wherein
   said process mining module uses said records in said event record database to determine patterns in said interactions.

As yet another aspect, the present document describes a method for determining whether an analyst's performance is to be marked for further analysis due to abnormal behaviour, the method comprising:
determining that a cybersecurity event has been addressed;
comparing said analyst's interactions in resolving said event with previously determined acceptable interactions for resolving events of a similar type to said event;
in the event said analyst's interactions deviate from said previously determined acceptable interactions for resolving events of a similar type to said event, determining that said analyst's performance is to be marked for further analysis.

The system includes the event record database that stores the records of interactions used/implemented by analysts in resolving events. The process mining module uses these event records to analyze past encounters with events and to determine recommended and non-recommended interactions/steps when dealing with events of a similar type. These recommended interactions can be provided to the assigned analyst when the event is assigned to the analyst. As well, the recommended interactions can be used to assess analyst performance by comparing the recommended interactions with the analyst's specific interactions for events of a similar type. Deviations or differences between the two can then be presented to the analyst as further training. Non-recommended interactions can be presented to the analyst as training in what not to do when addressing events of a similar type.

The recommended interactions can be derived from determined commonalities between or patterns in interactions executed by other analysts in resolving similarly typed events. Preferably, the event record database records all interactions executed by an analyst while addressing a specific event. These interactions are stored such that they are tagged to identify the analyst, the event, and the end result of the event. The interactions include the tools used, the steps performed using these tools, commands issued, sources of information consulted, search queries performed, keyboard entries, and mouse clicks.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system according to one aspect of the present invention;

FIG. 2 is a more detailed block diagram of a system similar to the system in FIG. 1;

FIG. 3 is a block diagram of an analyst modeling engine according to one aspect of the present invention;

FIG. 4 is a block diagram of an event classifier module according to one aspect of the present invention;

FIG. 5 is a block diagram of a module for estimating analyst stress and mood according to one aspect of the present invention;

FIG. 6 is a block diagram of a module for routing events according to one aspect of the present invention;

FIG. 7 is a block diagram of a quality assurance review module;

FIG. 8 shows a data flow diagram for a reinforcement learning method practiced by one aspect of the present invention;

FIG. 9A is a data flow diagram for a coaching and training module as implemented in one aspect of the present invention;

FIG. 9B is a block diagram illustrating the various potential submodules within the process mining module as well as the process mining module's interactions with other modules;

FIG. 10 is a flowchart of a method for assigning incoming events according to one aspect of the present invention;

FIG. 11 is a flowchart for a method for determining whether a quality assurance review is necessary according to one aspect of the present invention;

FIG. 12 is a flowchart of a process for dividing an incoming event into multiple subtasks; and

FIGS. 13 and 14 are block diagrams of an implementation of a system according to another aspect of the present invention.

### DETAILED DESCRIPTION

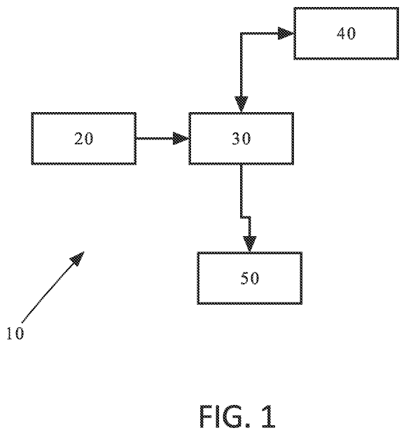

Referring to FIG. 1, a block diagram of a system according to one aspect of the present invention is illustrated. As can be seen, the system 10 includes an event assessment module 20, a processing module 30, an analyst database 40, and a dispatch module 50. The event assessment module 20 receives incoming events and assesses that incoming event, including determining the type of event, what may be necessary to address the event, what past events may be related to this event, as well as other characteristics of that incoming event. The event and its characteristics are then sent to the processing module 30. The processing module 30 then determines what analyst capabilities are necessary to address the needs of the incoming event. This is done by assessing the characteristics of the incoming event as well as the capabilities and characteristics of the available analysts as retrieved from the analyst database 40. The processing module 30 then matches one or more available analysts with the incoming event and dispatches the matched analyst(s)/event to the dispatch module 50. The dispatch module 50 then ensures that the matched analyst(s) have the proper data necessary to address the incoming event and sends the necessary data and characteristics of the incoming event (as well as the event itself) to the matched analyst(s). In addition, the assigned/matched analyst may also be provided with suggested (or recommended) resolution steps for the incoming event. These suggested resolution steps are culled and extracted from previously resolved encounters with similar incoming events.

It should be clear that, in some instances, an incoming event may be divided into multiple events by either the event assessment module 20 or by the processing module 30. These multiple events can then be assessed, individually, by the necessary modules for dispatch as explained above.

It should also be clear that, in one implementation, the system forms part of a Security Operation Center (SOC) and the incoming events are coming from a sensor and/or a subsystem. For such an implementation, security analysts are meant to investigate these events and to perform some actions. The incoming events are diverse and may require expertise in several domains.

The various aspects of the present invention are designed to implement, in one embodiment, a modelling of security analysts. The modelling allows for a number of measures such as:
1. Efficient event routing that leverages the analysts' behavioural model.
2. Skillset visualization for SOC leaders and managers. Such visualizations enable the SOC leaders and managers to better understand the strengths and weaknesses of their analysts across different event sub-categories.
3. Intelligent quality control at the SOC level since the models are able to flag the sub-optimum event assignments and also to flag events that were resolved with abnormal behaviour (i.e., resolution behaviour or steps that deviated from the behavioural model of the SOC analysts). Such events can be sent to another security analyst for quality assurance.
4. Event division based on the models of analysts and subcategory of events. For instance, to resolve an event, an analyst may be required to perform multiple steps. For each step, the system is capable of identifying different analysts who are expert at performing that step and then the system is able to divide the event into those sub-steps and send each step to the appropriate analyst with the necessary background information.
5. Dynamically identifying similar tasks based on skill sets in an online fashion by monitoring analysts' interaction by taking advantage of the impact of the Short Term Memory (STM) and the experience of analysts across different tasks. The system uses Knowledge Graphs to add human knowledge on top of tasks. This knowledge is documented by users through forms. This information will then be used to find overlapping “sub-skills” across different tasks, and to then quantify the importance of each through monitoring the impact of STM and delta analysis. In one example, in the context of cybersecurity, there are known two tasks (Task A and Task B) that are different types of Web Application specific tasks requiring an understanding of a specific database (e.g., dynamoDB). An analyst who resolved Task A will likely perform better at Task B within a few minutes of solving Task A due to less context switching and due to more overlap of skill sets. Deviation from normal performance of this analyst, along with the overlapped skill set (DynamoDB) will be used to quantify the relevance of this particular skill set in Task B and this analysis will occur in an online fashion. Experience of the analyst for Task A will also change their performance (speed and accuracy) on Task B due to the overlapping skill sets. This knowledge and circumstances can then be used in targeted training where the most required training topics for each analyst can be narrowed down.
6. Quantifying stress associated with a given task in real time without need for additional sensors. When an analyst performs a stressful task, it will affect their performance on their subsequent task due to context switching. The model of analyst skill sets allows for the quantification of this impact and allows the system to take appropriate measures to mitigate risk (e.g., pair the stressed analyst with a less stressful task after the stressful task, or flag the task after the stressful task for QA analysis, etc.)
7. Identification of the top performers among the analysts and the identification of the unique actions taken by the best analysts to solve problems. This identification can be performed using process mining techniques on stored records of previous encounters with incoming events/problems. This allows, by performing delta analysis (such as by comparing the actions of top performing analysts with a specific analyst's specific actions), for the provision of personalized feedback (e.g., training) to analysts who are not performing well, the monitoring of their feedback, and the implementation of appropriate action to change their behaviour over time using contextual data relating to tasks and data pertaining to analyst interaction. This feedback can be provided by various means such as the provision of personalized recommendations or the highlighting of certain data points in their user interface or the reshaping of the data in a manner to optimize analyst performance.

It should be clear that the present invention has a number of advantages to prior art systems. Simple recommender engines optimizing on resolution speed for tasks do not address the use case of a dynamic real-time environment. First, focusing on resolution speed does not take into account the accuracy of analysts' solutions. Such accuracy is critical in domains such as Cybersecurity, Healthcare, Teleoperation centers, Network Operation Centers, Help Desk, Emergency Respondents, Fraud Detection, Financial Analysis and more. Second, these recommender systems cannot accurately predict the task resolution time for analysts because of the static nature of this resolution time. Research suggests that both speed and accuracy for real time task resolution are variables that depend on several secondary factors (real time indicators or state of each analyst) such as Short Term Memory, Experience, Stress, Contextual awareness and more. In fact, the speed and accuracy of task resolution for the same analyst and for the same task can vary up to 5-10 minutes (as an example, TTR (time to resolution) would likely decrease if an analyst is solving a repetitive task due to Short Term Memory).

In one implementation, the system according to one aspect of the present invention is an application running on a data processing system. The system may be configured to learn from historic data, for example, by the use of artificial intelligence and process mining techniques. The historical data may include the expertise of security analysts in different knowledge areas and having different skillsets, security analyst command levels for different tools that are employed in a Security Operation Center, security analyst recent performance, event records that store all interactions or steps taken by analysts in resolving events of the same or similar type, security analyst recent performance for events originating from the same client organization/department/person within an organization, and security analyst performance on a related task that they recently solved. It should be clear that an analyst's interactions when resolving an incoming event includes the tools used, the steps performed using these tools, commands issued, sources of information consulted, as well as search queries performed. These and other data points may be used by the system to build an analyst's profile, with the profile being stored in the analyst database. As well, such data can also be used to create and maintain profiles for the various events and event types encountered by the system and by the analysts.

The system according to one aspect of the present invention has a number of capabilities. As an example, the system may be configured to learn from the real-time performance and resolution steps of security analysts on different events. The system can then use the data generated for improved system performance. In addition, the system may take advantage of an analyst's background including the analyst's education, work experience, and certifications. These can, of course, form part of an analyst's profile. This analyst profile may include analyst preference information, information about each analyst's stress levels, moods (e.g., an analyst's personality built up over time, such data that indicates that the analyst is frequently more stressed or in a bad mood on Monday mornings), and any other quantifiable data about each analyst.

In addition to storing each analyst's profile, the system also stores each analyst's previous performance relating to the events assigned to the analyst. This previous performance is then used by the system to modify/adjust future assignments to that same analyst such that the future assignments are reflective of or affected by the earlier performance. It should be clear that each analyst's profile may contain a static portion (e.g., education, gender) that is unlikely to change over time, and a dynamic portion (e.g., experience, recent performance) that is likely to change over time.

It should be clear that the information collected about a particular event during each interaction between an analyst and at least one event is automatically stored in a central database (which may include an event record database) for automatic retrieval later by the system when a similar event is encountered by the system. This information may include tools used, steps performed using those tools, commands issued to the system, sources of information consulted, and event resolution metrics such as resolution speed, and resolution accuracy. This data allows the system to build an event profile for each event that it encounters or receives. This event profile can then be stored in the central database. The profile may be updated with each future encounter of the same event or of a similar event or of events of a similar type.

It should be clear that an event record database can be used to store resolution steps from different analysts against each event encountered. These resolution steps (or interactions that led to a resolution of the event) can be later used to generate step-by-step guides on how best to resolve events of a particular type. This process may also help in automatically generating security playbooks that are used by analysts at a SOC as a step-by-step guide to solve a security event. Using such a list of recommended commands or recommended interactions or steps, the system can determine patterns of steps or interactions or sequences of steps or interactions that contributed to the resolution of the events. These patterns can be recommended to analysts when events of a similar type are encountered and can even form the core of steps or interactions that can be automated when events of a similar type are encountered.

The knowledge/data stored by the system in its databases can then be used by the processor module to more efficiently route incoming events to the relevant analysts. The processor module can thus assign events to analysts based on a variety of criteria based on the contents of the profiles of the analysts and on the profiles of the events.

The data stored in the system can also be used to perform intelligent quality control for actions taken by an analyst relating to incoming events. This is useful to identify occurrences such as when an analyst has missed crucial steps, or when an event has been assigned to a less than optimal security analyst or when a security analyst addresses an event that does not match the skillset of that analyst or when norm deviant behaviour is observed. Similarly, recommended interactions or steps can be analyzed along with the steps taken by a specific analyst to determine where the analyst deviated from the recommended interactions or steps. This difference can then be presented to the specific analyst during training after the event has been addressed.

In one embodiment, the intelligent automated system provides an interface to the higher management to visualize skillsets of the analysts.

The system may also be useful in addressing business realities. As an example, if business realities (e.g., service level agreements (SLA), a budget, or other resource considerations) dictate that a security analyst with certain characteristics should handle a particular event or class of events or analysts should resolve an event within a time-constraint imposed by SLA, the system can be programmed to detect such occurrences and to act accordingly.

In terms of communicating with analysts, the system may interact with security analysts using audio, video, or text. The system may also use gamification techniques to maintain a security analyst's interest towards resolving an event. In addition, the system may be programmed to assign events of interest to an analyst, small-step progress, other psychological incentives to enable an analyst to resolve an event more accurately or more correctly, and provide tips at each step based on the past behavior of other analysts who have successfully resolved events of a similar type.

As noted above, the system may divide an incoming event into multiple events. For such an occurrence, the system divides an incoming event into sub-tasks and these tasks are then sent to different security analysts. The system then interacts with those different analysts to ensure an effective resolution of the overall event. The system may also be programmed to have a number of capabilities suitable for use in an analyst centered organization. Such capabilities may include stress estimation, knowledge representation, planning, learning, and natural language processing.

As noted above, the system may use artificial intelligence techniques as well as artificial intelligence-based components. The artificial intelligence techniques and components may include a Reinforcement Learning method, a clustering technique (e.g., using k-nearest neighbours), a neural network, and mathematical techniques such as regression models. The system may also use process mining techniques to model the interaction of analysts, during the event resolution process, with the systems used for event resolution.

Data for each analyst may be gathered from their keyboard and mouse typing patterns, image or video data of the analyst resolving tasks, analyst interactions with other security analysts, tools used and steps performed in those tools, commands issued to the system, and sources of information consulted in existing knowledge-base to resolve an event related problem. It should be clear that, preferably, all of the interactions that an analyst has with the system and/or other data processing systems are logged and recorded while the analyst is addressing/dealing with a specific event. This includes all keystrokes entered by the analyst, all mouse clicks, all websites/databases consulted by the analyst, all search queries (and results for those queries) that the analyst may have entered/made, all commands entered into the system or entered into a system that is used for event resolution, any changes the analyst may have made to any settings in the system that is the subject of the incoming event, as well as any other input and/or output to/from the system and/or the system that is the subject of the incoming event. It should be clear that, preferably, the input/output data gathering begins once the analyst is assigned the incoming event and ends when the incoming event has been addressed/closed. It should be clear the closing the incoming event may result in a successful resolution of the event or in an unsuccessful resolution of the event. In some implementations, the closing of the incoming event may also occur when analysis/addressing of the event is put on hold and the event is classified as ongoing.

Also preferably, the data gathered for each incoming event for a specific analyst is kept together in one data structure or is at least associated with one data structure per event. Such an event record for an incoming event would include all of the interactions that an assigned analyst would have with the system and/or with the system that is the subject of the incoming event. From the above, each event record would, preferably, include all of the analyst's mouse clicks, keyboard entries, websites/databases visited/consulted, search queries executed (as well as at least some of the search results from these queries), any online consultations the analyst may have had online with other analysts or specialists, as well as any video or capture of the screen that may have been taken of the analyst while the analyst is addressing/resolving the incoming event. Also preferably, each event record would be tagged/associated with: a unique event record ID, at least one analyst ID (to detail which analyst(s) may have dealt with the incoming event), at least one event type (with each event possibly having more than one event type), and an event result. For clarity, the event type may be based on the security issue, the end result of the security issue, the problem caused by the security issue, or any other possible classifications for events. As an example, event types may include data breach, credential compromising, data theft, resource locking, unauthorized data locking/encryption, network breach, email address spoofing, network address spoofing, as well as others. For the event result, an event record may have a single event result—the event record may be associated with an event result that the event was resolved successfully (successful resolution), unsuccessful resolution, or on-going. As can be imagined, when an event record is initially created, it can have an end result that details an on-going event as the analyst interactions are continuously stored in the event record.

For greater clarity, as noted above, a single event may be broken up into smaller events and each of these smaller events may be assigned separately to different analysts. For a larger event, the event record may comprise the event IDs for the various smaller events that the larger event has been broken up into. Thus, a single large event may have 4-5 different event IDs inside its event record to details that the large event was broken up into 4-5 smaller events and that each of these smaller events were assigned to separate analysts. Each of these smaller events would have their own event records and these event records would have, within them, the various interactions that the analyst(s) may have had with the system or with the system that is the subject of the incoming event.

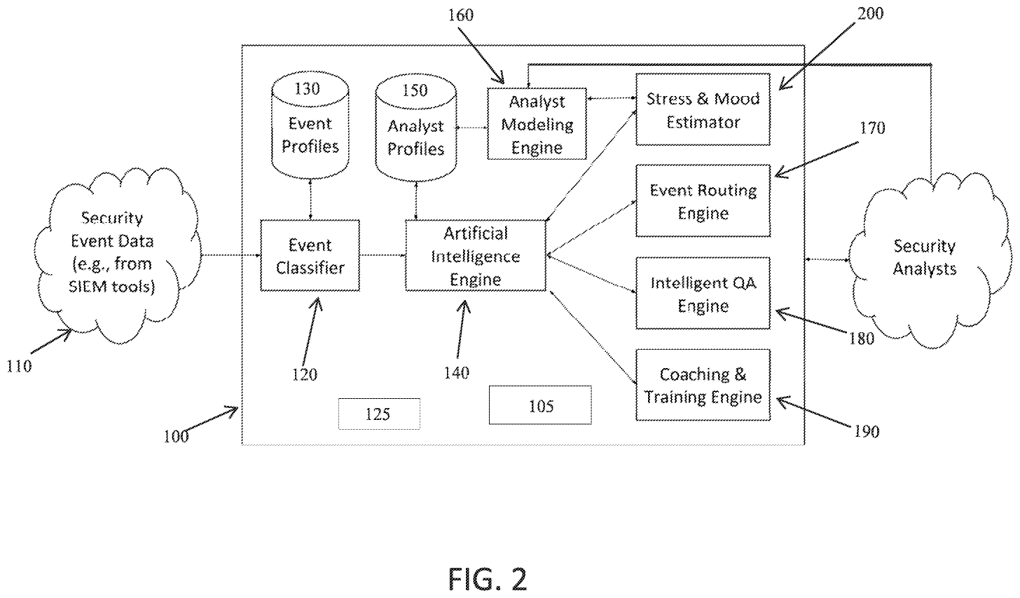

Referring to FIG. 2, one embodiment of the present invention is schematically illustrated.

In FIG. 2, the system 100 receives incoming event data 110. The incoming event data 110 is fed to the ‘Event Classifier’ 120, which consults the ‘Event Profiles’ database 130 to classify the incoming event as one of a number of internal event categories. This incoming event data is then passed on the ‘Artificial Intelligence Engine’ 140 along with meta data about the incoming event. The system 100 also receives data by way of the ‘Analyst Modeling Engine’ module 160. This module 160 receives a variety of data regarding each analyst including each analyst's past and present performance for events that are assigned to each analyst. The data regarding each analyst is stored in the analyst profile database 150 and may be retrieved as necessary. The ‘Artificial Intelligence Engine’ 140 uses the event data and the analysts' profiles (from the analyst database 150) to determine event routing. Determinations regarding event routing are passed to the ‘Event Routing Engine’ 170. If an event's resolution needs to be checked, the system uses the module 140 along with the ‘Intelligent QA Engine’ module 180 to perform intelligent quality assurance. Analyst coaching and training is performed through the ‘Coaching & Training Engine’ module 190. A Stress Estimator module 200 receives real-time performance indicators for each analyst and updates the profiles of these analysts through the ‘Analyst Modeling Engine’ 160.

For greater clarity, the system 100 may include a process mining module 105 and an event record database 125. The process mining module 105 may receive data from the event record database 125 as well from event profiles database 150 and analyst profiles database 150. The event record database 125 contains the event records for past incoming events and, as such, contains at least one copy of the records of the analyst transactions for each event. The process mining module 105 assesses and analyzes the various event records to mine the records for useful conclusions and data. The process mining module 105 is used after events have been addressed to determine if there is any actionable/useful intelligence or lessons that can be derived from data gathered from addressing/resolving previous instances of events. Depending on the configuration of the process mining module 105, the output of the process mining module may be used by any of the other modules in the system 100.

The analysis performed by the process mining module 105 may be analyst centric and, as such, its output may be used by the coaching and training engine 190 (e.g., what did analyst X do wrong compared to how other analysts handled the same/similar events). Similarly, the analysis may be event result oriented so that determining actionable intelligence may involve determining which steps were taken to resolve past events. It should be clear that the process mining module 105 can be configured to “mine” the event records for useful data based on the experience of the analysts when dealing with previous events. As an example, the process mining module can retrieve relevant event records to form datasets that can be used as the input into machine learning models. For example, to determine which interactions were used by analysts that resulted in a successful resolution of events of type Y, the process mining module 105 queries the event record database 125 to retrieve all event records tagged with event type Y and for which the event was resolved successfully. The retrieved results can then be analyzed to determine which interactions were present in the retrieved results. This can be performed using machine learning/AI or this can be performed using a brute force method by counting how many instances of each interaction is present in the retrieved results, with the interactions having the highest counts as candidates for contributing to the event resolution. Mining other useful lessons from previous events can also be performed by querying the event records based on the desired criteria. As an example, to determine what a specific analyst X has done to resolve events of type Y, the event record database can be queried for event records tagged with the analyst ID for analyst X, the event type Y, and with a successful resolution. The results can then be further analyzed, in conjunction with event records for successfully resolved events of type Y, to determine where analyst interactions deviated from the interactions of other analysts who also successfully resolved events of type Y. The results of such an analysis can then be used by the coaching and training engine to provide constructive criticism to analyst X when dealing with events of type Y.

It should be clear that the components shown inside the large rectangle in FIG. 2 forms part of one implementation of one aspect of the present invention. The cloud and the two components ‘Analysts’ Performance on Events' and ‘Analysts' Background and Historic Data’ is provided by the Security Operations Center (SOC).

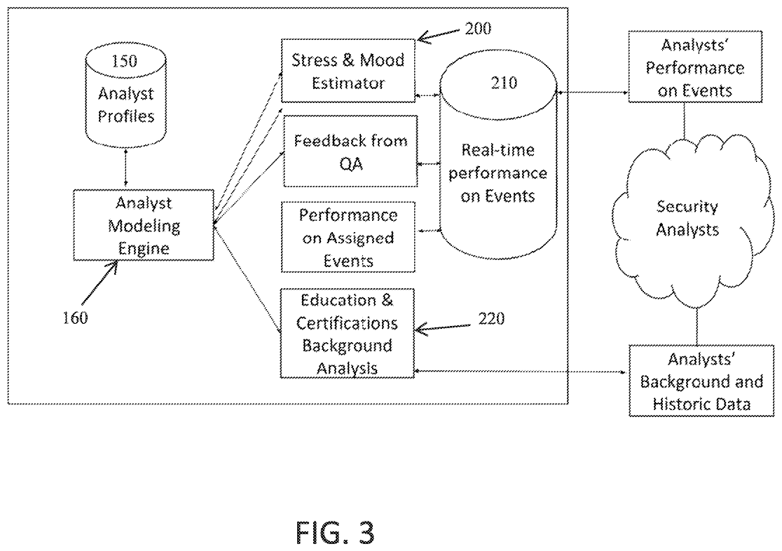

Further components of the system according to one aspect of the present invention can be seen in the block diagram of FIG. 3. As can be seen, the data ‘Analysts’ Performance on Events' is stored in a database ‘Real-time Performance on Events’ 210 while the data ‘Analysts' Background and Historic Data’ is used in an analysis of each analyst's background (block 220). As noted above, the system may use the process mining module 105 to extract the steps taken by analysts in resolving one or more specific events. The extracted sequence of steps (or individual steps) may, if desired, be saved and segregated into a different database. These steps can then be used in the formulation of a guidebook or recommended recipe/formula for addressing specific events or event types. Alternatively, these steps can be, depending on the nature of the steps, the basis for a set of automated steps to be executed when specific events or event types are encountered. process mining module

It should be clear that any real-time data regarding analyst interaction includes their performance on the assigned events (both for Quality Assurance and event resolution purposes) as well as their interaction with their terminal. The performance of each analyst on their assigned tasks and the corresponding results from a quality assurance analysis of the completed tasks is used by the Analyst Modeling Engine 160 to create a model of each analyst's performance. The interaction data with the analyst's terminal is used by the process mining module to determine which tools were used and what steps were performed with those tools, what commands were issued to the system, and what sources of information consulted. In one implementation, the interaction data related to the analysts' keystrokes and mouse movements are used by the ‘Stress & Mood Analysis’ module 200 to determine that analyst's stress levels and mood. Historic data relating to each analyst's education, certifications, and performance for events that were previously resolved are also used by the Analyst Modeling Engine 160 as necessary. The Analyst Modeling Engine 160 uses these modules and the data associated with them to build each analyst profile.

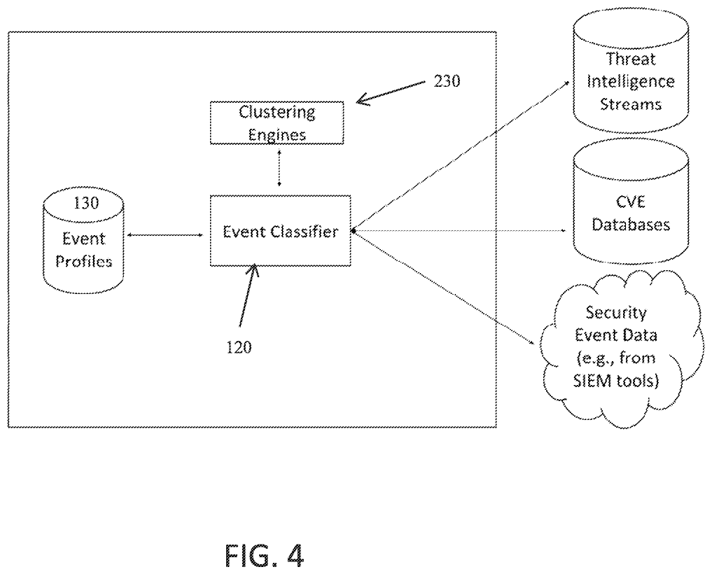

Referring to FIG. 4, a block diagram explaining the event classifier function of the system is illustrated. As can be seen, the Event Classifier module 120 uses existing open source or private Threat Intelligence Streams and CVE Databases to create a categorization of existing threats. This categorization is performed using clustering engines 230, with the clustering engines using machine learning techniques to implement semi-supervised learning to result in a clustering of the incoming data. The created Event Profiles are then stored in an Event Profiles Database. The Event Classifier module 120 also uses data from security tools (e.g., a Security Information and Event Management System (SIEM) or a Security Orchestration, Automation, and Response (SOAR)) to validate the created Event Profiles. It should be clear that the output of the Event Classifier module 120 works with the event record database to ensure that each event record is properly identified in terms of the event's type(s).

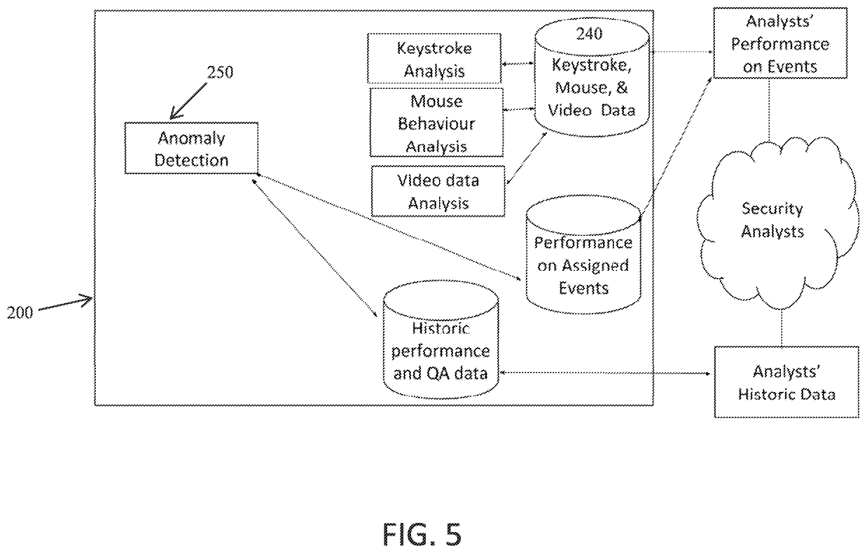

Referring to FIG. 5, the components of the Stress and Mood Estimator module 200 are illustrated schematically. As can be seen, the module 200 includes a database 240 of keystroke, mouse, and video data for each analyst. This data is analyzed to determine each analyst's mood and/or stress level.

As noted above, real-time analyst interaction generates data by way of their performance on assigned events (both for Quality Assurance and event resolution purposes) and their interaction with their terminal. The raw data of their keystroke and mouse movements and, optionally, through a video feed of the analysts when they are resolving events is captured for storage and/or analysis of the system. Analysis is performed using a baseline of normal analyst behaviour. This baseline is established using historic data for these data points. An anomaly detection submodule 250 compares established baseline performance against the real-time behaviour of each analyst to estimate a mood and/or stress level of each analyst.

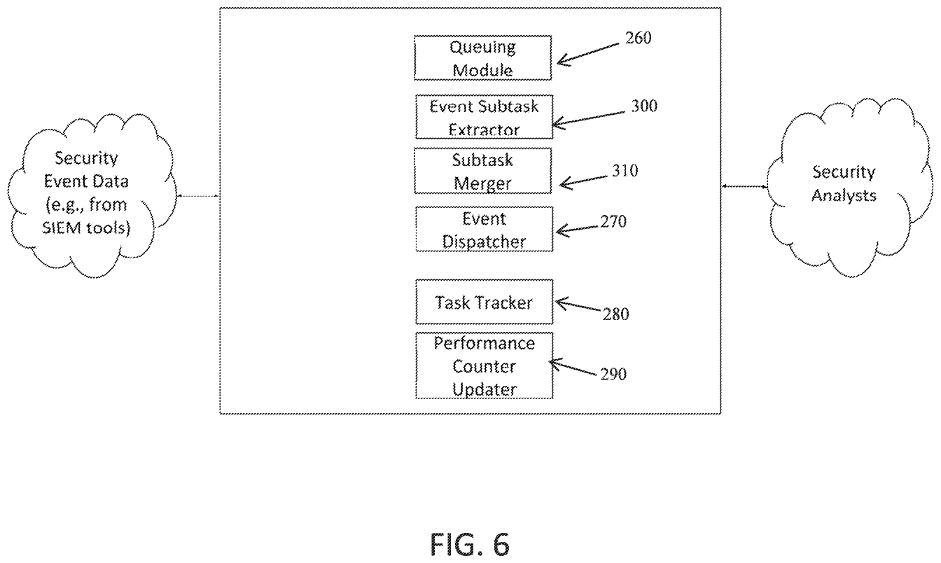

Referring to FIG. 6, the submodules within the Event Routing Engine 170 are illustrated. As noted above, the Event Routing Engine 170 receives output from the Artificial Intelligence Engine 140 as to which analyst(s) are to receive the data regarding a current or incoming event. This recommendation from the module 140 can take the form of an ordered list of analysts that are suitable for the current event in decreasing order. The Event Routing Engine uses the ‘Queuing Module’ 260 to estimate the current work load of the first analyst in the list. If that first analyst's workload crosses a certain threshold, then the next analyst in the list is considered. The process continues until an analyst in the list is found that has a workload that has not crossed the predetermined threshold. If all the analysts in the list are busy, then the event is randomly assigned to one of the top 25% analysts for that event type. The Event Dispatcher 270 dispatches the event as a task to the selected analyst. The Task Tracker 280 keeps track of when the task gets completed and, as soon as the task is completed by the assigned analyst, the Task Tracker updates the queuing model and the performance counters for that analyst through Performance Counter Updater module 290.

Regarding the other submodules, the Event Subtask Extractor Module 300 is responsible for dividing an event into smaller subtasks. If the system chooses to divide an event into subtasks or smaller events, then the Artificial Intelligence Engine 140 provides a recommendation for each subtask as an ordered list of analysts. As with regular events, the Event Routing Engine 170 uses the ‘Queuing Module’ to estimate the current work load of the top recommended analysts for each subtask. Each subtask is assigned in a similar fashion as described above for individual events. Once the analysts to be assigned have been identified, the Event Dispatcher dispatches each subtask to the chosen/selected analysts. The Task Tracker keeps track of all the subtasks and, when all the subtasks are completed, the Task Tracker uses the Subtask Merger 310 to merge the results of the subtasks. The Task Tracker then updates the queuing model and the performance counters for all the analysts involved through the Performance Counter Updater module 290. It should be clear that, in one implementation, the process mining module can determine, from an analysis of the event records for specific top performing analysts, the interaction steps taken by these top performing analysts to resolve specific events or specific types of events. These interaction steps or sequence of steps can also be provided to the assigned analyst while that assigned analyst is dealing with a specific similar event or while the assigned analyst is in training/coaching. Depending on the configuration of the system, a more proactive approach can be taken such that recommended actions/interactions may be provided to assigned analysts as events are on-going. For a less proactive approach, once an event is concluded (whether the event is resolved or not), the analyst assigned to the concluded event can be provided with coaching based on the differences between the recommended actions/interactions and what steps were actually taken by the assigned analyst. This post-mortem or debrief can be useful in that it would highlight what the analyst may have done wrong or what may not have been the most effective approach taken by the analyst.

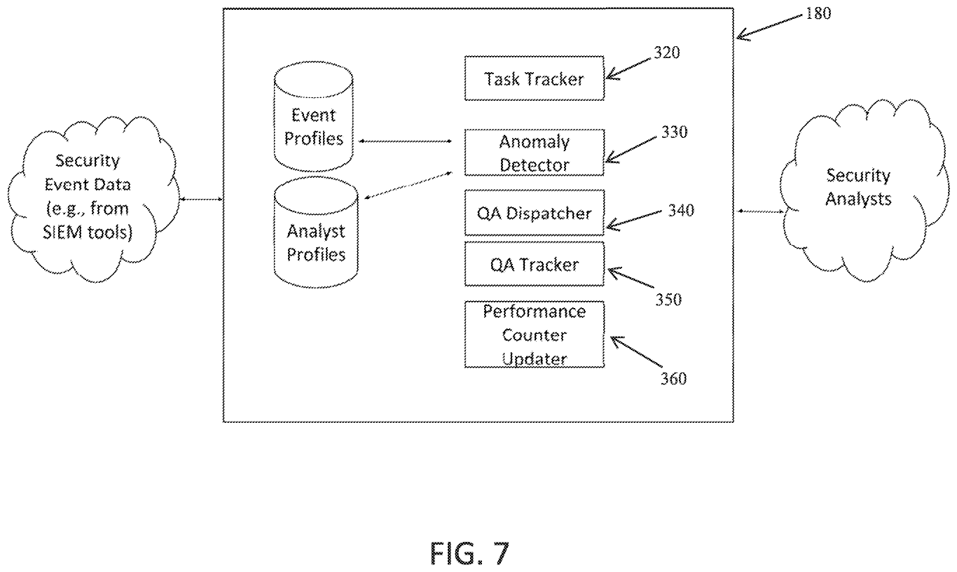

Referring to FIG. 7, a block diagram of the Intelligent QA module 180 is illustrated. The Intelligent QA module 180 assesses an analyst's actions towards addressing an event and determines whether the actions taken are suitable in light of what other analysts have done in the past and in light of that specific analyst's background. The Task Tracker module 320 tracks the current performance of an analyst on a specific task. This performance is measured in terms of tools used and the steps performed using those tools and command issued to the system as well as a timeline of these resolution steps. If the performance of the analyst does not match their stored profile on past correct event resolutions (using the anomaly detection module 330), then this event is flagged for QA dispatching by way of the QA Dispatcher 340. Alternatively, if the stress levels of the current analyst are higher than normal or if the analyst does not have sufficient experience with similar events in the past, the event is also flagged for QA. The QA dispatcher module 340 identifies the best analyst that could perform QA for the current event using the Artificial Intelligence Engine. The QA Tracker 350 keeps track of when the task gets completed and, as soon as the task is completed by the analyst, the QA Tracker module updates the performance counters for that analyst through Performance Counter Updater module 360.

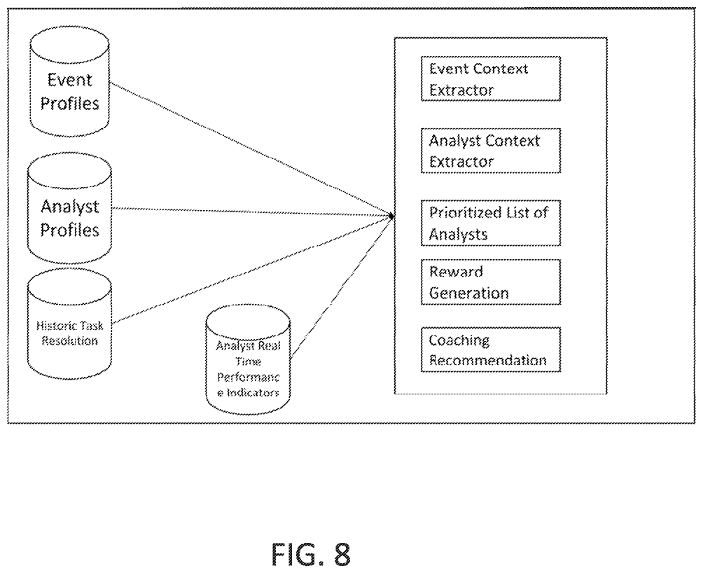

Referring to FIG. 8, illustrated is a block diagram showing the data flow for a reinforced learning method used by the Artificial Intelligence Engine in the system. The Reinforcement Learning method takes as input data from sources such as Event Profiles, Analyst Profiles, Historic Task Resolution, details of Analysts, and the Real Time Performance Indicators for analysts. In the method, the Event Context Extractor module takes Event Profile data and extracts features pertaining to event categories and to metadata associated with features to generate Event Context data. The Analyst Context Extractor takes Analyst Profile data for an active analyst along with each active analyst's Real Time Performance Indicators (including, but not limited to, Short Term Memory, Experience, Stress/Fatigue, Learning Rate, Industry familiarity and more) to generate Analyst Context data. The Event Context data is then associated with Analyst Context data for each active analyst. Previous rewards generated by the Reward Generation module are then used to produce a prioritized list of analysts. This prioritized list can include a defined randomization factor to optimize the exploration of the decision space. Rewards are generated using several factors, including time to resolve issues/events (TTR) and an accuracy score (if any) where the reward is inversely proportional to TTR and directly proportional to Accuracy.

In addition to the above, the prioritized list of analysts is passed through the Coaching Recommendation module. This module uses the Historic Task Resolution information for analysts to list recommendations and is meant to aid analysts in their work.

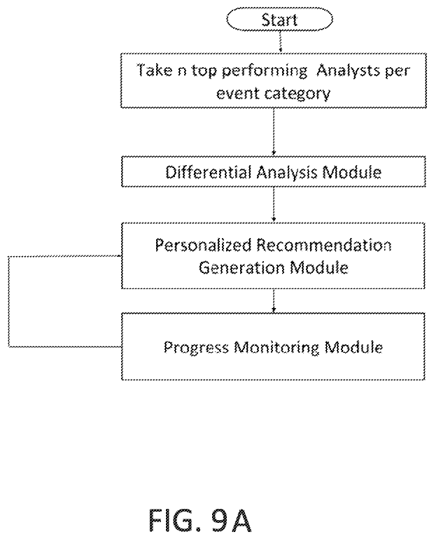

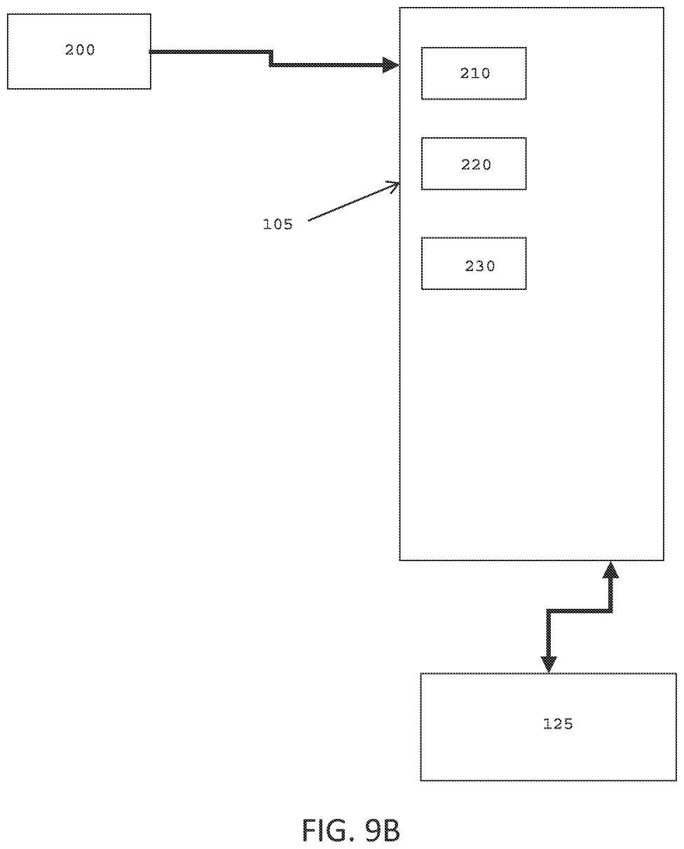

Referring to FIG. 9A, a data flow block diagram for an implementation of a coaching and training module used in one aspect of the present invention. As can be seen from FIG. 9A, the coaching and training module first identifies the n top performing analysts per event category. These top analysts are identified by consulting the event logs to determine analysts who have completed tasks accurately and in the shortest amount of time possible. Data regarding the identified top analysts is then passed to a Differential Analysis module that analyzes the steps for event resolution to identify the unique characteristics, actions and behaviours of these identified top analysts. It is these unique qualities of the top analysts that lead to their much better performance relative to other analysts. The identified data is then used to generate personalized recommendations using the Personalized Recommendation Generation Module. A Progress Monitoring Module periodically evaluates any changes in performance of the analysts and such an evaluation can then be used to further adjust or fine tune the recommendations generated by the Personalized Recommendation Generation Module. As can be imagined, the data used by the coaching and training module may come from the process mining module as well as from the event record database.

Referring to FIG. 9B, the submodules within the Process Mining module 105 are illustrated. As can be seen, the module 105 cooperates with the event record database 125 containing records of the interactions/steps that were taken by analysts in past resolution processes. This historic data provides rich contextual information. It receives ‘Analyst's Resolution Steps’ 200 for the current event. This data is compared with the past resolution steps taken by the baseline of previously correctly resolved events by the same analyst using an anomaly detection module. The process mining module uses the Process Discovery submodule 210 to construct the process flow and associates a timeline for each step within that flow. The root cause analysis module 220 takes the process data of an analyst and compares it with data from top performing analysts to discover the causes of inefficiencies. These causes are then used to intelligently train and coach analysts. The Discover Automation Potential submodule 230 is used to compare the resolution steps for each event to determine common sets of actions taken by analysts. This module takes into account the contextual information about the analyst, the organization, and the task and is able to discern when process resolution steps differ between different targets (e.g., different departments within an organization). This knowledge is then used to suggest strategies on how to automate the steps that most or all analysts usually (or always) take to resolve events of that event type. Since the module 230 has the knowledge about how contextual factors affect the process, the module 230, in one implementation, is able to tailor out-of-the-box processes (e.g., playbooks in SOC).

As can be seen from FIG. 9B, the process mining module determines, on a per analyst basis, what that analyst did in the past to resolve events of a specific type. This determines what that analyst's pattern of interactions is with respect to events of that type. The metrics of that analyst's pattern of interactions are then determined, such as timelines for each step/interaction, overall resolution times, etc. That analyst's pattern of interactions is also compared with recommended patterns of interactions from other successful resolutions of events of a similar type by other analysts (preferably top analysts). The difference between the two are then determined and the difference in the metrics are compared to determine where this specific analyst may have deviated or have been inefficient. Such data can then be used when providing training to the specific analyst. Essentially, best practices for analysts dealing with a specific event type are determined from the patterns of interactions from previously resolved events from well performing analysts (e.g., the top analysts). These best practices or recommended interactions are then compared with the pattern of interactions for a specific analyst when that analyst is addressing events of a similar type. The differences and the resulting possible inefficiencies as well as potential errors can then be presented to the specific analyst during training.

It should be clear that the process mining module 105 operates in conjunction with the event record database. As noted above, it is preferable that the event record database be a record of every interaction/step taken by every analyst when dealing with events. Also preferably, the event record database is organized on a per event manner such that all interactions/steps taken by an analyst when dealing with a specific event is stored in one specific event record for that event. This event record can be stored regardless of whether the event was successfully resolved, not resolved, or is on-going. The process mining module can process each event record and can compare each event record with event records for other similar events or other events of a similar type. Depending on how the process mining module is configured, this analysis can determine commonalities (in interactions or steps taken) between event records for similar event types that have been successfully resolved and for commonalities between event records for similar events that had not been successfully resolved. The commonalities for successfully resolved events can be gathered and be used to create a dynamic set of instructions on how to address similar events (i.e., events of a similar type). For commonalities (in interactions/steps taken) between non-successfully resolved events, these commonalities can also be gathered and be used to determine steps/interactions to not implement when faced with events of a similar type. These non-recommended interactions can be provided to analysts so that they will not implement them when dealing with similar event types. In addition, the system, by way of a real-time QA monitoring (or coaching) of analyst interactions, can flag a specific analyst for QA training if the specific analyst's interactions substantially conform to a non-recommended sequence of interactions/steps. What this means is that, before a specific analyst wastes time in implementing what had previously been determined to be a non-productive sequence of interactions, the system flags/warns the specific analyst of the potential issue. This can be dealt with by flagging the analyst for a QA session or by assigning a different analyst to the event. As with the recommended interactions, the non-recommended interactions can be used to create dynamic sequences of interactions that should not be taken when dealing with specific event types. As can be imagined, the specific analyst's current interactions are pattern matched with a non-recommended sequence of interactions/steps. If there is a match (or a close enough match) between the non-recommended sequence and the analyst's sequence of current interactions, an alarm can be given to the analyst of the potential issue.

As a variant to the above, the recommended interactions can, depending on the interactions, be the basis for automated steps/interactions to be implemented when events of a specific type are encountered. Similarly, the non-recommended steps/interactions may be the basis for automated flagging/alerts (or even blocking) once an analyst's interactions begin to follow the sequence of non-recommended interactions.

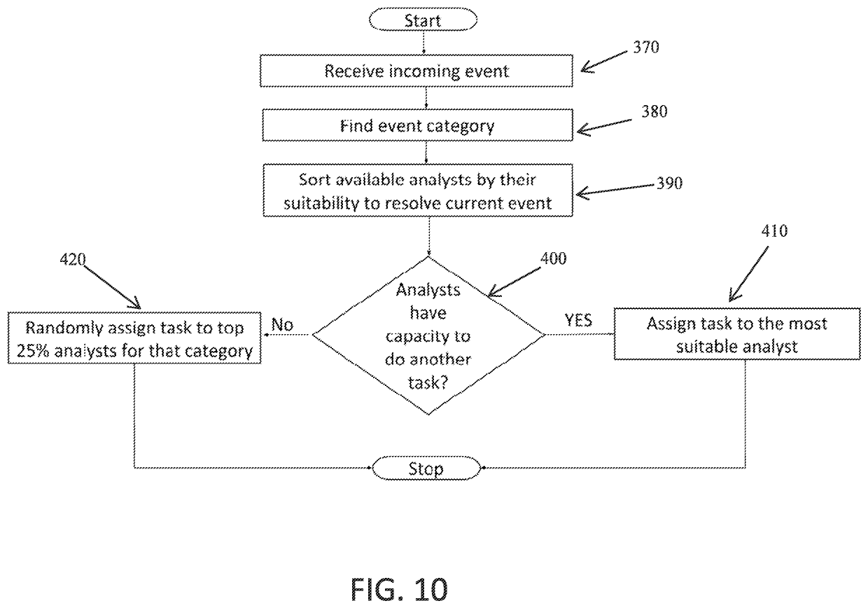

Referring to FIG. 10, a flowchart detailing the steps in a method executed by the system is illustrated. This method is an implementation of the method explained above for the system as a whole. The method begins with the system receiving an incoming event (step 370). The Event Classifier module then identifies the event category that it belongs to or, as explained above, the event is classified (step 380). A generated event profile for the incoming event is sent to the Artificial Intelligence Engine and the Artificial Intelligence Engine retrieves the profiles of suitable analysts from the database. From these profiles, the Engine then creates a sorted list of analysts (sorted by most suitable to resolve the current event) in step 390. The Event Routing Engine then starts at the first analyst in the sorted list and determines whether this analyst has the capacity to address the current event based on the available space in their assigned event queue based on a predefined threshold (e.g., a queue of five events) in decision 400. As part of decision 400, the Event Routing Engine cycles through the sorted list to find a suitable analyst with available capacity. Once a suitable analyst is found, the incoming event is assigned to this suitable and available analyst (step 410). If no analyst in the list has available capacity in their queues to resolve the event, the Event Routing Engine assigns the event randomly to one of the top 25% of the analysts in the sorted list (step 420).

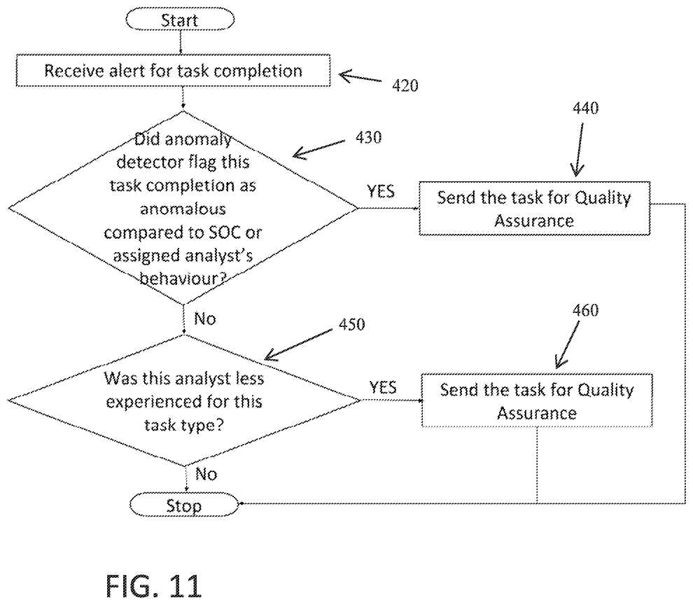

Referring to FIG. 11, a flowchart for a method executed by the system is illustrated. This method determines whether an event's resolution is to be forwarded for a quality assurance (QA) analysis. Whenever an event is completed or resolved, the Intelligent QA module receives an alert (step 420). As explained below, the module performs three comparisons to determine if the analyst's completion/resolution behaviour is to be flagged for a quality assurance review.

The QA module compares (step 430) the completion behaviour of the analyst that completed the task with data for normal behaviour for this same analyst (as stored in the relevant analyst profile). This data includes timeline of tools used and the steps performed using those tools and command issued to the system during the resolution steps, and the stress profile of the analyst. If it is found that the analyst's behaviour is different (i.e., deviant or deviates from the stored normal behaviour), the resolved event is flagged for a quality assurance review (decision 440).

The QA module also compares (step 430) the completion behaviour of this analyst for this event with stored normal behaviour data for the average analyst. This averaged normal behaviour is determined by averaging the stored behaviour data for all the relevant analysts in the database (or by averaging the stored behaviour data for a specified subset of the analysts with stored data). If it is found that the analyst's behaviour is, again, different from the averaged normal behaviour data, the resolved event is flagged for a quality assurance review (step 440).

The QA module also compares the current event assigned analyst's experience with a predetermined assessment criterion (step 450). If the analyst's experience is determined to be less than a desired level, the resolved event is also flagged for a quality assurance review (step 460).

It should, however, be clear that, in one implementation, an event can only be flagged for a QA review once. Thus, for this implementation, if an event resolution by an analyst has been flagged for a QA review for, for example, an analyst's behaviour that is outside his normal behaviour, the same event cannot be flagged for another QA review if the analyst's experience is less than the predetermined criteria.

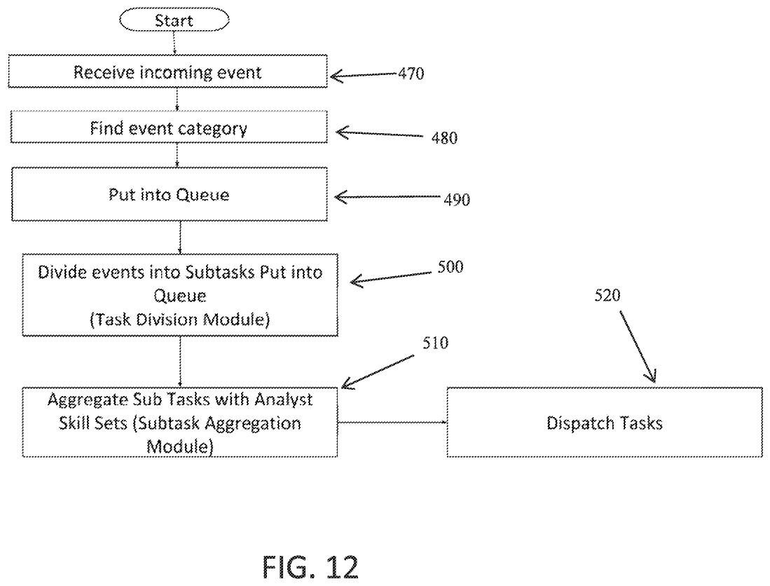

Referring to FIG. 12, a flowchart detailing the steps in another method executed by the system is illustrated. As can be seen, the method details the steps for dividing an incoming event into multiple smaller tasks or events. The method begins with the system receiving an incoming event (step 470). Each incoming event is then categorized (step 480) and then pushed into a queue (step 490). Events in the queue are broken down into subtasks or smaller events by the Task Division Module (step 500). The Subtask Aggregation Module then bundles the tasks in an intelligent manner, taking into consideration the skill sets of the various analysts (step 510). The bundled tasks are then dispatched to the appropriate analyst (step 520).

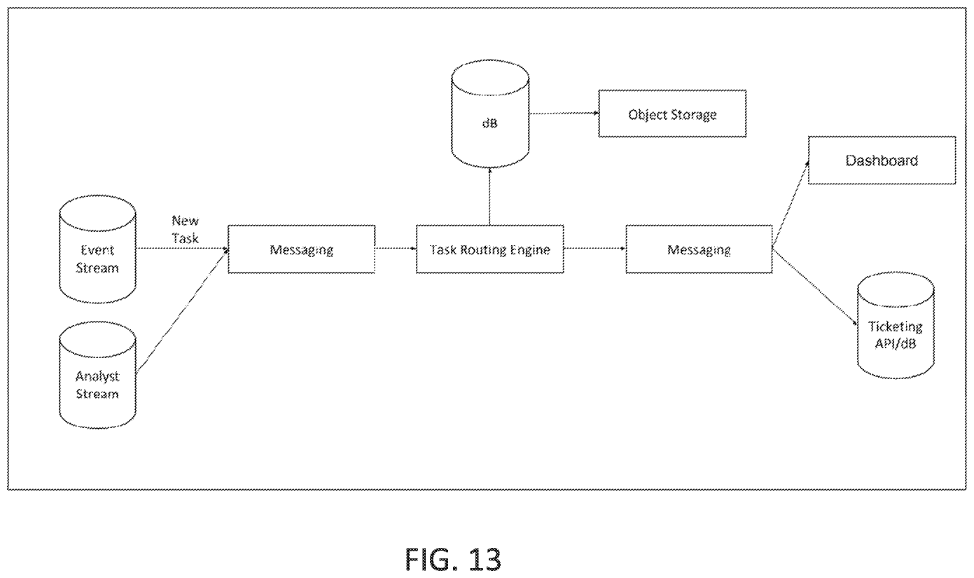

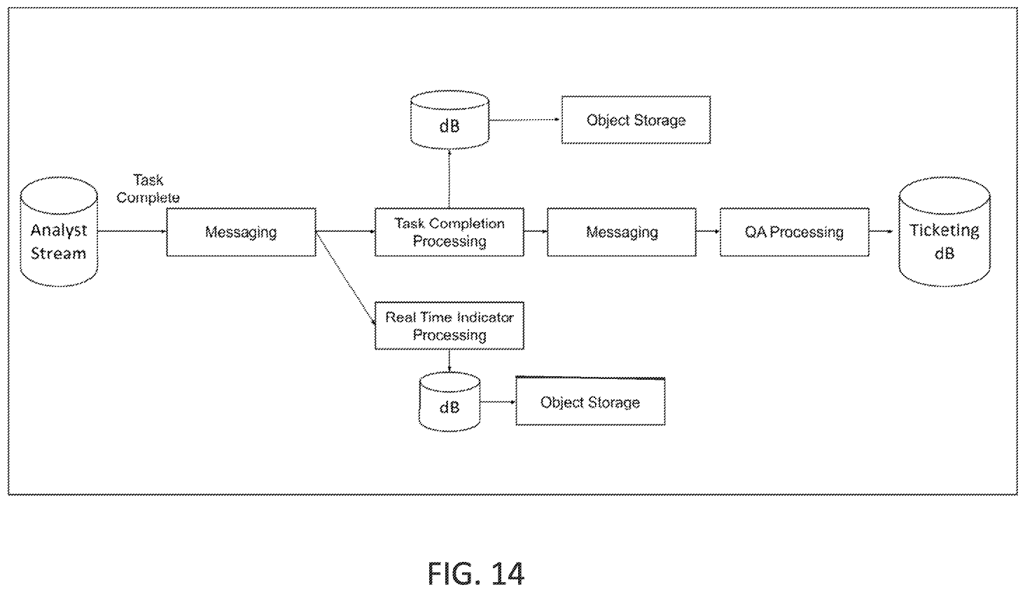

Regarding implementation, the system may be implemented in multiple ways. FIGS. 13 and 14 schematically illustrate implementations of the above noted system.

As noted above, the system according to one aspect of the present invention takes in as input multiple instances of data relating to incoming Events, Analyst Interactions, and Audit/QA trails. Processed data and the results of data processing are then used to populate a Dashboard. Changes to data and to event assignments are pushed to a Ticking API/database.

Incoming events and any new tasks generated by incoming events are pushed onto a messaging system. The Task Routing Engine subscribes to this messaging system. Through the messaging system, the Task Routing Engine will receive data pertaining to a new event, along with an existing analyst model that is used to identify one or more appropriate analysts to address a specific task/event. Once one or more analysts have been selected or identified, the selection is stored on the database and is pushed to the messaging system. This triggers an enforcement on the Ticketing API/database. The dashboard is then updated to detail who is dealing with which event/task.

Once a task is completed or an event has been resolved, the messaging system is triggered, and a specific task/event is inserted that is then routed to Task Completion Processing. A Job database is then updated, and the update will also get saved on an object storage area for future processing/data retention. The Task Completion Processing will also trigger a QA Processing task that will evaluate if an audit is required on the recently completed task/event. If an audit is required, a subsequent change to the Ticketing database is made.

The Task Completion event will also trigger a Real Time Indicator Processing task. This task is responsible for updating the counters associated with secondary features such as Short Term Memory, Analyst Experience, Analyst Learning Rate, Analyst Interaction Experience, and others. These features and the data generated are stored in a database as well as in the object storage area for further future processing/data retention.

It should be clear that the various aspects of the present invention may be implemented as software modules in an overall software system. As such, the present invention may thus take the form of computer executable instructions that, when executed, implements various software modules with predefined functions.

Additionally, it should be clear that, unless otherwise specified, any references herein to ‘image’ or to ‘images’ refer to a digital image or to digital images, comprising pixels or picture cells. Likewise, any references to an ‘audio file’ or to ‘audio files’ refer to digital audio files, unless otherwise specified. ‘Video’, ‘video files’, ‘data objects’, ‘data files’ and all other such terms should be taken to mean digital files and/or data objects, unless otherwise specified.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A system for managing incoming events and analysts, the system comprising:
an event classifier module for classifying an incoming event;
an analyst database storing analyst profiles of said analysts;
a processing module for determining which analyst is to be assigned to address said incoming event based on an analyst profile in said analyst database;
a routing engine for routing data related to said incoming event to an analyst based on a determination by said processing module as to which analyst is to be assigned to address said incoming event;
wherein
said processing module receives data regarding said incoming event from said event classifier module and receives analyst profiles from said analyst database;
said processing module determines which analyst is to be assigned to said incoming event based on said analyst profiles and on a classification of said incoming event.

2. The system according to claim 1, further comprising an event profile database storing event profiles, said incoming event being classified based on one or more of said event profiles in said event profile database.

3. The system according to claim 1, further comprising an analyst modeling engine, said analyst modeling engine receiving input from analyst interactions and using data from said analyst interactions to determine analyst profiles stored in said analyst database.

4. The system according to claim 3, wherein said analyst interactions comprise at least one of:
keyboard key presses;
mouse movements;
event resolution steps;
databases accesses;
search engine queries;
accesses to networked resources; and
video data of said analyst resolving at least one event.

5. The system according to claim 3, wherein said analyst modeling engine receives input from a stress and mood estimator module to determine said analyst profiles stored in said analyst database.

6. The system according to claim 3, wherein said analyst modeling engine receives input from a quality assurance module to determine said analyst profiles stored in said analyst database.

7. The system according to claim 3, wherein said analyst modeling engine receives external input to determine said analyst profiles stored in said analyst database, said external input comprising at least one of:
an analyst's education;
an analyst's certifications;
an analyst's experience in resolving similar events;
steps taken by an analyst to resolve at least one similar event;
an analyst's prior performance in resolving similar events.

8. The system according to claim 2, wherein said event classifier module uses at least one machine learning technique to classify said incoming event.

9. The system according to claim 8, wherein said at least one machine learning technique comprises clustering of incoming data.

10. The system according to claim 1, wherein at least one incoming event is divided into subtasks and each subtask is separately assigned to different analysts.

11. The system according to claim 6, wherein said quality assurance module is engaged when at least one triggering event occurs, said at least one triggering event being at least one of:
a stress level of an analyst is higher than a predetermined threshold;
a stress level of an analyst is higher than a predetermined normal level;
an analyst's performance is less than an expected performance level for said analyst as determined by said analyst's analyst profile;
a sequence of steps taken by an analyst in resolving an incoming event conforms to a portion of a predetermined sequence of steps previously determined to not contribute to a resolution of events of a similar type to said incoming event; and
an analyst's level of experience with a type of incoming event is less than a predetermined threshold, said incoming event being assigned to said analyst.

12. The system according to claim 1, wherein said incoming events are incoming cyber security events and said analysts are security analysts.

13. The system according to claim 1 wherein said system further comprises a process mining module for determining patterns in analyst interactions used while said analysts are addressing incoming events.

14. The system according to claim 1, wherein said system further comprises an event record database, said event record database containing records of interactions by analysts for every event said analysts encounter as said analysts resolve each event.

15. The system according to claim 14, wherein said event record database contains, for each event, at least one record of every interaction each analyst performs while addressing said each event.

16. The system according to claim 15, wherein said interaction each analyst performs includes:
keyboard key presses;
mouse movements;
event resolution steps;
data tools accessed;
tools accessed for event resolution;
databases accesses;
system commands entered;
search engine queries; and
accesses to networked resources.

17. The system according to claim 13, wherein said patterns are sequences of analyst interactions that contribute to a resolution of events of a similar type.

18. The system according to claim 13, wherein said patterns are sequences of analyst interactions that do not contribute to a resolution of events of a similar type.

19. The system according to claim 18, wherein said patterns are used in training analysts on what interactions are useful and what interactions are not useful in resolving events of said similar type.

20. The system according to claim 14, wherein said event record database is used by a process mining module for determining patterns in analyst interactions used while analysts are addressing incoming events.

21. The system according to claim 17, wherein said patterns are used to construct recommended interactions that are recommended to analysts when said analysts encounter incoming events of said similar type.

22. The system according to claim 1, wherein said analyst profiles includes data derived from at least one real time performance indicator, said at least one real time performance indicator being one or more of:
short term memory;
experience;
stress level;
fatigue level;
learning rate;
technology stack familiarity;
targeted individual familiarity; and
industry familiarity.

23. A method for addressing an incoming event, the method comprising:
a) receiving said incoming event;
b) classifying said incoming event based on stored event profiles;
c) determining at least one analyst suitable to address said incoming event, said at least one analyst being determined to be suitable based on a plurality of stored analyst profiles;
d) assigning said incoming event to one of said at least one analyst determined in step c); and
e) dispatching data relating to said incoming event to said analyst assigned in step d).

24. The method according to claim 23, wherein step c) comprises assessing said stored analyst profiles to assess at least one quality of said analysts for suitability to address said incoming event, wherein said at least one quality is at least one of:
an analyst's education;
an analyst's certifications;
an analyst's experience in resolving similar events;
an analyst's prior performance for steps taken in resolving similar events; and
an analyst's work capacity to address another incoming event.

25. The method according to claim 23, wherein a resolution of an incoming event is flagged for a quality assurance review when at least one triggering event occurs, said at least one triggering event being at least one of:
a stress level of an analyst assigned to said incoming event is higher than a predetermined threshold;
a stress level of an analyst assigned to said incoming event is higher than a predetermined normal level;
an analyst's performance is less than an expected performance level for said analyst as determined by said analyst's analyst profile, said analyst being assigned to said incoming event;
a sequence of steps taken by an analyst in resolving an incoming event conforms to a portion of a predetermined sequence of steps previously determined to not contribute to a resolution of events of a similar type to said incoming event; and
an analyst's level of experience with a type of incoming event is less than a predetermined threshold, said incoming event being assigned to said analyst.

26. The method according to claim 23, further comprising estimating a stress level of an analyst to generate data to be used in determining an analyst's suitability to address an incoming event.

27. The method according to claim 26, wherein said stress level is estimated based on analyst interactions, said analyst interactions comprising at least one of:
keyboard key presses;
mouse movements;
event resolution steps;
databases accesses;
system commands entered;
search engine queries; and
accesses to networked resources.
and
video data of said analyst resolving at least one event.

28. The method according to claim 23, further comprising adjusting said stored analyst profiles based on at least one of:
estimated stress levels of an analyst;
estimated mood of an analyst;
performance data for an analyst in addressing an incoming event; and
performance data for an analyst in addressing an incoming event as determined by a quality assurance review.

29. The method according to claim 23, wherein step b) comprises using at least one machine learning technique to classify said incoming event.

30. The method according to claim 29, wherein said at least one machine learning technique comprises clustering of incoming data.

31. The method according to claim 23, further comprising generating an analyst's profile data based on at least one real time performance indicator, said at least one real time performance indicator being one or more of:
short term memory;
experience;
stress level;
fatigue level;
learning rate; and
industry familiarity.

32. The method according to claim 23, further comprising a step of recording interactions used by said analyst while addressing said event.

33. The method according to claim 23, wherein step e) comprises sending recommended interactions to said analyst assigned in step d), said recommended interactions being at least one interaction that has been determined to have contributed to past resolution of at least one event of a similar type to said incoming event.

34. The method according to claim 33, wherein said recommended interactions are derived by a process mining module from patterns in interactions used by analysts while are addressing events of a similar type to said incoming event.

35. The method according to claim 23, further comprising providing training to said analyst assigned in step d) after said incoming event has been addressed.

36. The method according to claim 35, wherein said training comprises detailing to said analyst assigned in step d) at least one of:
recommended interactions and said analyst's interactions and detailing a difference between said recommended interactions and said analyst's interactions; and
errors in said analyst's interactions when addressing said incoming event, said errors being based on an analysis of previous encounters with events of a similar type to said incoming event and an analysis of said analyst's interactions.

37. The method according to claim 35, wherein said training comprises providing said analyst assigned in step d) with at least one of:
recommended interactions derived from an analysis of previous events resolved by other analysts; and
non-recommended interactions, said non-recommended interactions being at least one interaction that has been determined to have not contributed to past resolution of at least one event of a similar type to said incoming event.

38. A system for extracting useful information from interactions used by analysts while addressing incoming cybersecurity events, the system comprising:
an event record database, said event record database containing records of interactions by analysts for every event said analysts encounter as said analysts resolve each event;
a process mining module for determining patterns in said interactions used while said analysts are addressing incoming events;
wherein
said process mining module uses said records in said event record database to determine patterns in said interactions.

39. The system according to claim 38, wherein said interactions includes:
keyboard key presses;
mouse movements;
event resolution steps;
databases accesses;
system commands entered;
search engine queries; and
accesses to networked resources.

40. The system according to claim 39, wherein said event record database contains a record of all interactions of said analysts while said analysts address said incoming events.

41. The system according to claim 38, wherein said patterns include sequences of analyst interactions that contributed to a previous resolution of events of a similar type.

42. The system according to claim 38, wherein said patterns are sequences of analyst interactions that do not contribute to a resolution of events of a similar type.

43. The system according to claim 42, wherein said patterns are used in training analysts on at least one of:
what interactions are not useful in resolving events of said similar type; and
what interactions are useful in resolving events of said similar type.

44. The system according to claim 41, wherein said patterns are used to construct recommended interactions that are recommended to analysts when said analysts encounter incoming events of said similar type.

45. The system according to claim 44, wherein said recommended interactions are contrasted with specific recorded interactions of a specific analyst when training said specific analyst about where their interactions deviated from said recommended interactions.

46. The system according to claim 41, wherein said patterns are derived from event records of analysts who have successfully resolved events of said similar type.

47. A method for determining whether an analyst's performance is to be marked for further analysis due to abnormal behaviour, the method comprising:
determining that a cybersecurity event has been addressed;
comparing said analyst's interactions in resolving said event with previously determined acceptable interactions for resolving events of a similar type to said event;
in the event said analyst's interactions deviate from said previously determined acceptable interactions for resolving events of a similar type to said event, determining that said analyst's performance is to be marked for further analysis.

48. The method according to claim 47, wherein said previously determined acceptable interactions for resolving events of a similar type to said event is at least one of:
interactions executed by said analyst in resolving previous events of a similar type to said event; and
interactions executed by other analysts in resolving previous events of a similar type to said event.

49. The method according to claim 47, wherein said analyst's performance is to be marked for further analysis in the event said performance is analyzed to not conform to at least one predetermined standard.
